(19) United States
(12) Patent Application Publication
(10) Pub. No.: US 2015/0122001 A1
(43) Pub. Date: May 7, 2015

(54) DEVICE FOR CALCULATING AMOUNT OF REDUCED FUEL CONSUMPTION, AND PROGRAM FOR DISPLAYING CALCULATION, AS WELL AS DEVICE FOR CALCULATING AMOUNT OF REDUCED CO2 EXHAUST, AND PROGRAM FOR DISPLAYING CALCULATION

(71) Applicants: JAPAN ECO SUPPORTER CO., LTD., Amori (JP); ECO SUPPORTER INTERNATIONAL CO., LTD., Chiba (JP)

(72) Inventors: Yasushi Shikanai, Mutsu-shi (JP); Tomio Taguchi, Nagano-shi (JP)

(73) Assignees: ECO SUPPORTER INTERNATIONAL CO., LTD., Noda-shi, Chiba (JP); JAPAN ECO SUPPORTER CO., LTD., Mutsu-shi, Aomori (JP)

(21) Appl. No.: 14/404,954

(22) PCT Filed: Mar. 29, 2013
(86) PCT No.: PCT/JP2013/059679

§ 371 Date: Dec. 2, 2014

(30) Foreign Application Priority Data
Jun. 3, 2012 (JP) 2012-126639
Mar. 28, 2013 (JP) 2013-070699

(51) Int. Cl. G01F 9/00

(52) U.S. Cl. CPC G01F 9/00
USPC 73/114.52

(57) ABSTRACT

PROBLEM TO BE SOLVED: To provide a fuel consumption reduction amount calculation device, a fuel consumption reduction amount calculation and display program, a carbon dioxide emission reduction amount calculation device, and a carbon dioxide emission reduction amount calculation and display program, that digitize the fuel consumption reduction amounts or CO₂ emission reduction amounts of a vehicle or a drier or the other heating appliances.

SOLUTION: A fuel consumption reduction amount calculation device 10 inputs base line data 14 and 16 of a vehicle before mounting a combustion improvement device and project data 18 and 20 of the vehicle after mounting the combustion improvement device, and displays a value calculated by subtracting annual fuel consumption amount taken from project data from a value calculated by dividing annual travel distance taken from the project data by the fuel consumption rate taken from the base line data. Also, a carbon dioxide emission reduction amount calculation device 34 displays a value calculated by subtracting an emission amount that is calculated by multiplying an emission coefficient by the annual fuel consumption amount taken from project data from the emission amount calculated by multiplying the annual fuel consumption amount taken from the project data by the annual travel distance taken from the project data divided by the fuel consumption rate taken from the base line data.

### TECHNICAL FIELD

The present disclosure relates to a fuel consumption reduction amount calculation device, a calculation and display program thereof, a carbon dioxide emission reduction amount calculation device, and a calculation and display program thereof that calculate the fuel consumption reduction amount or the carbon dioxide CO₂ emission reduction amount for which a combustion improvement device, that improves burning of a fuel in an internal combustion engine of a vehicle or other heating appliances such as a dryer and the like, has been installed.

### BACKGROUND ART

The amount of greenhouse gas emissions of many countries has been increasing every year, and reduction of these emissions is an important issue. Much of the greenhouse gases emitted by a transportation section is from vehicles.

Conventionally, combustion improvement devices are designed to improve fuel combustion and can reduce fuel consumption and CO₂ emissions by installing the improvement device on an internal combustion engine of a vehicle (for example, electromagnetic wave processing unit of the combustion air of Japanese Patent Publication No. H7-59972).

The electromagnetic wave processing unit for air combustion described in Japanese Patent Publication No. H7-.59972 includes a thermal insulator, a reflector attached to this thermal insulator, and an irradiator made of ceramics that is disposed on the reflector and irradiates electromagnetic waves toward the combustion air. This device is wound around the engine air intake system pipe (engine air duct hose) of a vehicle, and is secured. Then, as intake oxygen is excited by the electromagnetic waves irradiated from the irradiator, CO₂ and the like can be reduced, and fuel consumption can be reduced.

However, with the use of improvement devices like the one mentioned above, it is difficult to quantify and to visualize the improvement of fuel consumption (fuel consumption reduction amount) and the CO2 emission reduction amount.

Typically, when fuel consumption efficiencies are compared, the fuel consumption efficiencies are calculated only based on travel distance data and fuel consumption amount.

However, fuel consumption efficiencies constantly fluctuate depending on driving conditions.

For example, regardless whether” a combustion improvement device providing an obvious combustion efficiency improvement has been mounted, the fuel consumption efficiency is decreased if engine idling is not stopped. On the other hand, if engine idling is stopped, the fuel consumption efficiency is improved, compared to continuous idling, regardless whether” a combustion improvement device has not been mounted. Moreover, regardless whether” a combustion improvement device is mounted on a vehicle operating on local roads, the fuel consumption efficiency may be less than a vehicle operating on a highway without a combustion improvement device. Moreover, regardless whether” a combustion improvement device is not mounted, the fuel consumption efficiency may improve during particular seasons, such as in summer compared with other seasons, such as during the winter seasons. In this way, the influence on fuel consumption efficiency by driving conditions is significant, and effects obtained by mounting the combustion improvement device could not otherwise be obtained. That is, any improvements in fuel consumption efficiency could not have been determined just with the mounting of the combustion improvement device.

In order to solve the above-mentioned problem, a vehicle fuel consumption rate evaluation device, a vehicle fuel consumption rate estimation system, and a recording medium thereof are provided that can reasonably and appropriately evaluate the fuel consumption efficiency regardless whether” the vehicle conditions vary (for example, patent literature 1).

### CITATION LIST

### Patent Literature

[Patent literature 1] Japanese Patent No. 3314870.

### SUMMARY OF INVENTION

### Technical Problem

The vehicle fuel consumption rate evaluator described in the patent literature 1 relates to a fuel consumption rate evaluator that calculates an evaluation value and displays on a display device the evaluation value which is calculated by:

quantifying fuel consumption rate which is a value of a vehicle travel distance divided by a fuel consumption amount, fixed data such as vehicle type and the like regarding the vehicle, a cargo load capacity and the like;

multiplying or dividing the quantified fuel consumption rate, fixed data and/or cargo load capacity by a numerical value to which a part or all of the quantified values are added; or

adding the fuel consumption rate and the above-mentioned added values; or

subtracting the above-mentioned added values from the fuel consumption rate. In this way, values for which different travel conditions for each vehicle (fixed data or flow data) are considered are calculated. Thus, evaluation of the fuel consumption efficiency of each vehicle can be reasonable. Fixed data are, for example, vehicle type, displacement volume, weight, engine type, axle load, and the like. Moreover, flow data are, for example, a cargo load capacity, a road traffic congestion condition, the weather, temperature, heating time, air conditioning time, a tire and a tire wearing condition and the like.

However, the vehicle fuel consumption rate evaluator of the patent literature 1 quantifies fixed data such as a vehicle type, displacement volume, weight, an engine type, an axle load, and the like and flow data such as a cargo load capacity, a road traffic congestion condition, the weather, temperature, heating time, air conditioning time, tire type and tire wearing condition and the like, and quantifies evaluation of the fuel consumption efficiency of each vehicle and the vehicle fuel consumption rate evaluator of the patent literature 1 was not a device which quantifies a fuel consumption efficiency improvement value (values of evaluation value reduction amount and/or CO2 emission reduction amount).

The present invention solves the above-mentioned problem. The objective of the present invention is to provide a fuel consumption reduction amount calculation device, a calculation and display program thereof, a carbon dioxide emission reduction amount calculation device, and a calculation and display program thereof that quantify the fuel consumption reduction amount or the carbon dioxide CO₂ emission reduction amount for a vehicle or other heating appliances such as a dryer and the like.

### Solution to Problem

The fuel consumption reduction amount calculation device of the present invention enables the input, via an input means, of baseline data which is travel data that includes an annual travel distance and annual fuel consumption amount of a vehicle stationed in a business facility located at a certain location, the baseline data being of the vehicle before mounting a combustion improvement device that improves fuel combustion in an internal combustion engine of a vehicle, and inputs project data of the vehicle after mounting the combustion improvement device, and

displays via an output means with a numerical value calculated by subtracting the annual fuel consumption amounts taken from the project data from a baseline consumption amount which is the annual travel distance of the project data divided by the baseline fuel consumption efficiency calculated by dividing the annual travel distance in the baseline data by the annual fuel consumption amount, the numerical value being the subtracted value if the annual fuel consumption amount taken from the project data is smaller than the baseline consumption amount, and the numerical value being minus value if the annual fuel consumption amount take from the project data is larger than the baseline consumption amount.

The carbon dioxide emission reduction amount calculation device of the present disclosure enables the input, via an input means, of baseline data which is travel data that includes an annual travel distance and annual fuel consumption amount for a vehicle stationed in a business facility located at a certain location, the baseline data being taken from the vehicle before mounting a combustion improvement device that improves fuel combustion in an internal combustion engine of the vehicle, and inputs project data regarding the vehicle after mounting the combustion improvement device, and

displays via an output means with a numerical value calculated by subtracting a project emission amount which is calculated by multiplying the emission coefficient of the fuel of the vehicle by the annual fuel consumption amount taken from the project data, from baseline emission amount which is calculated by multiplying the emission coefficient by a baseline consumption amount which is the annual travel distance taken from the project data divided by the baseline fuel consumption efficiency calculated by dividing the annual travel distance taken from the baseline data by the annual fuel consumption amount, the numerical value being the subtracted value if the project emission amount is smaller than the baseline emission amount, and the numerical value being a negative value if the project emission amount is larger than the baseline emission amount.

The fuel consumption reduction amount calculation and display program of the present disclosure causes a computer;

in which baseline data, which is travel data that includes an annual travel distance and an annual fuel consumption amount of a vehicle stationed in a business facility located at a certain location, the baseline data being of the vehicle before mounting a combustion improvement device that improves fuel combustion in an internal combustion engine of the vehicle, and project data of the vehicle after mounting the combustion improvement device, are inputted into the computer via an input means,

to execute:

a step for calculating a baseline fuel consumption efficiency which is obtained by dividing the annual travel distance taken from the baseline data by the annual fuel consumption amount;

a step for calculating a baseline consumption amount which is obtained by dividing the annual travel distance taken from the project data by the baseline fuel consumption efficiency;

a step for calculating a fuel consumption reduction amount which is obtained by subtracting the annual fuel consumption amount taken from the project data from the baseline fuel consumption amount; and

a step for displaying the fuel consumption reduction amount on an output means with the numerical value of the calculated fuel consumption reduction amount if the annual fuel consumption amount taken from the project data is smaller than the baseline consumption amount, and the numerical value being minus value if the annual fuel consumption amount taken from the project data is larger than the baseline consumption amount.

The carbon dioxide emission reduction amount calculation and display program of the present disclosure that causes a computer;

in which baseline data, which is travel data that includes an annual travel distance and an annual fuel consumption amount of a vehicle stationed in a business facility located at a certain location, the baseline data being of the vehicle before mounting a combustion improvement device that improves fuel combustion in an internal combustion engine of the vehicle, and project data of the vehicle after mounting the combustion improvement device, are inputted into the computer via an input means,

to execute:

a step for calculating a baseline fuel consumption efficiency which is obtained by dividing the annual travel distance taken from the baseline data by the annual fuel consumption amount;

a step for calculating a baseline consumption amount which is obtained by dividing the annual travel distance taken from the project data by the baseline fuel consumption efficiency;

a step for calculating a carbon dioxide emission reduction amount which is obtained by subtracting project emission amount which is calculated by multiplying the emission coefficient by the annual fuel consumption amount taken from the project data from the baseline emission amount calculated by multiplying the emission coefficient of the fuel of the vehicle by baseline consumption amount; and

a step for displaying the carbon dioxide emission reduction amount on an output means with the numerical value of the calculated carbon dioxide emission reduction amount if the project emission amount is smaller than the baseline emission amount, and the numerical value being minus value if the project emission amount is larger than the baseline emission amount.

The fuel consumption reduction amount calculation device of the present disclosure that inputs, via an input means, baseline data which is combustion data which includes annual combustion time and annual fuel consumption amount of a heating appliance such as a dryer and the like which are permanently installed at a certain location, the baseline data being of the heating appliance before mounting a combustion improvement device that improves fuel combustion in an internal combustion engine of the heating appliance such as a dryer and the like, and inputs project data of the heating appliance after mounting the combustion improvement device, and

displays via an output means with a numerical value calculated by subtracting the annual fuel consumption amount taken from the project data from baseline consumption amount which is the annual combustion time taken from the project data divided by the baseline fuel consumption efficiency which is calculated by dividing the annual combustion time taken from the baseline data, the numerical value being the subtracted value if the annual fuel consumption amount taken from the project data is smaller than the baseline consumption amount, and the numerical value being minus value if the annual fuel consumption amount taken from the project data is larger than the baseline consumption amount.

The carbon dioxide emission reduction amount calculation device of the present disclosure that inputs, via an input means, baseline data which is combustion data that includes annual combustion time and the annual fuel consumption amount of a heating appliance such as a dryer and the like which are permanently installed and annual fuel consumption amount located at a certain location, the baseline data being of the heating appliance before mounting a combustion improvement device that improves fuel combustion in an internal combustion engine of the heating appliance such as a dryer and the like, and inputs project data of the heating appliance after mounting the combustion improvement device, and

displays via an output means with a numerical value calculated by subtracting project emission amount which is calculated by multiplying the emission coefficient by the annual fuel consumption amount taken from the project data, from baseline emission amount which is calculated by multiplying the emission coefficient of the fuel of the heating appliance by a baseline consumption amount which is the annual combustion time taken from the project data divided by the baseline fuel consumption efficiency calculated by dividing the annual combustion time taken from the baseline data by the annual fuel consumption amount, the numerical value being the subtracted value if the project emission amount is smaller than the baseline emission amount, and the numerical value being minus value if the project emission amount is larger than the baseline emission amount.

The fuel consumption reduction amount calculation and display program of the present disclosure that causes a computer;

in which baseline data, which is combustion data that includes annual combustion time and annual fuel consumption amount of a heating appliance such as a dryer and the like which are permanently installed at a certain location, the baseline data being of the heating appliance before mounting a combustion improvement device that improves fuel combustion in an internal combustion engine of the heating appliance such as a dryer and the like, and project data of the heating appliance after mounting the combustion improvement device, are inputted into the computer via an input means,

to execute:

a step for calculating a baseline fuel consumption efficiency which is obtained by dividing the annual combustion time taken from the baseline data by the annual fuel consumption amount;

a step for calculating a baseline consumption amount which is obtained by dividing the annual combustion time taken from the project data by the baseline fuel consumption efficiency;

a step for calculating a fuel consumption reduction amount calculated by subtracting the annual fuel consumption amount taken from the project data from the baseline consumption amount; and

a step for displaying the fuel consumption reduction amount on an output means with the numerical value of the calculated fuel consumption reduction amount if the annual fuel consumption amount taken from the project data is smaller than the baseline consumption amount, and the numerical value being minus value if the annual fuel consumption amount taken from the project data is larger than the baseline consumption amount.

### Advantageous Effects of Invention

The carbon dioxide emission reduction amount calculation and display program that causes a computer;

in which baseline data, which is combustion data that includes annual combustion time and annual fuel consumption amount of a heating appliance such as a dryer and the like which are permanently installed at a certain location, the baseline data being of the heating appliance before mounting a combustion improvement device that improves fuel combustion in an internal combustion engine of the heating appliance such as a dryer and the like, and project data of the heating appliance after mounting the combustion improvement device, are inputted into the computer via an input means,

to execute:

a step for calculating a baseline fuel consumption efficiency which is obtained by dividing the annual combustion time taken from the baseline data by the annual fuel consumption amount;

a step for calculating a baseline consumption amount which is obtained by dividing the annual combustion time taken from the project data by the baseline fuel consumption efficiency;

a step for calculating a carbon dioxide emission reduction amount calculated by subtracting project emission amount calculated by multiplying the emission coefficient by the annual fuel consumption amount taken from the project data from the baseline emission amount calculated by multiplying the emission coefficient of the fuel of the vehicle by baseline consumption amount; and

a step for displaying the carbon dioxide emission reduction amount on an output means with the numerical value of the calculated carbon dioxide emission reduction amount if the project emission amount is smaller than the baseline emission amount, and the numerical value being minus value if the project emission amount is larger than the baseline emission amount.

The present invention quantifies the fuel consumption reduction amount and the CO₂ emission reduction amount of vehicles and heating appliances based on the travel distance data, the fuel consumption amount, and combustion time data before and after mounting the combustion improvement device for all vehicles and heating appliances such as a dryer and the like for which the fuel consumption reduction amount and the CO₂ emission reduction amount are to be calculated. Thereby, fair and appropriate fuel consumption efficiency improvement value including travel conditions and combustion conditions can be provided.

### BRIEF DESCRIPTION OF DRAWINGS

FIG. 1(a) and FIG. 1(b) are schematic diagrams showing an example of a combustion improvement device used in the present disclosure;

FIG. 2(a) and FIG. 2(b) are schematic diagrams showing the principle of the combustion improvement device and combustion improvement effect used in the present disclosure;

FIG. 3 is a block diagram of a fuel consumption reduction amount calculation device and the carbon dioxide emission reduction amount calculation device according to the present disclosure;

FIG. 4 is a flow chart of the fuel consumption reduction amount calculation and display program and the carbon dioxide emission reduction amount calculation and display program which operate in the fuel consumption reduction amount calculation device and the carbon dioxide emission reduction amount calculation device according to the present disclosure;

FIG. 5 is an example of display contents such as the fuel consumption reduction amount and the carbon dioxide emission reduction amount displayed on the output means of the fuel consumption reduction amount calculation device and the carbon dioxide emission reduction amount calculation device according to the present disclosure.

### DESCRIPTION OF EMBODIMENTS

The present invention achieves visualizing fluctuation of the fuel consumption before and after mounting combustion improvement device.

### Examples

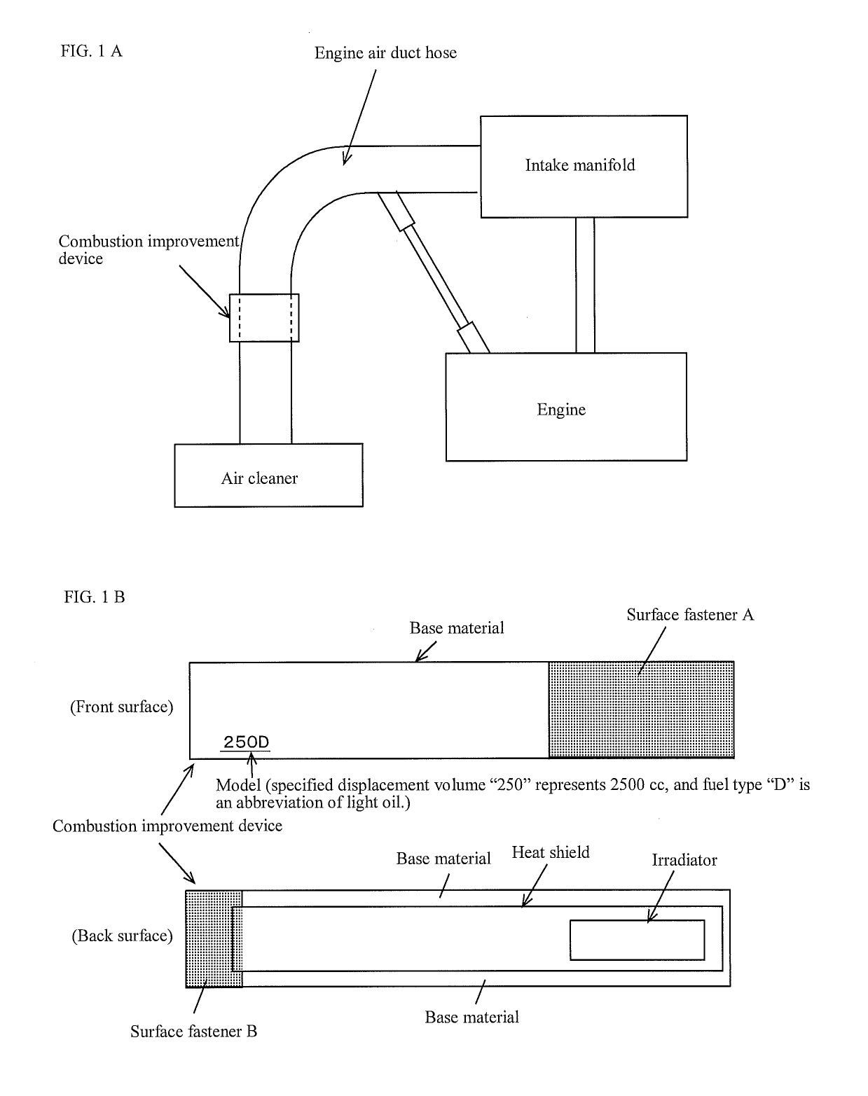

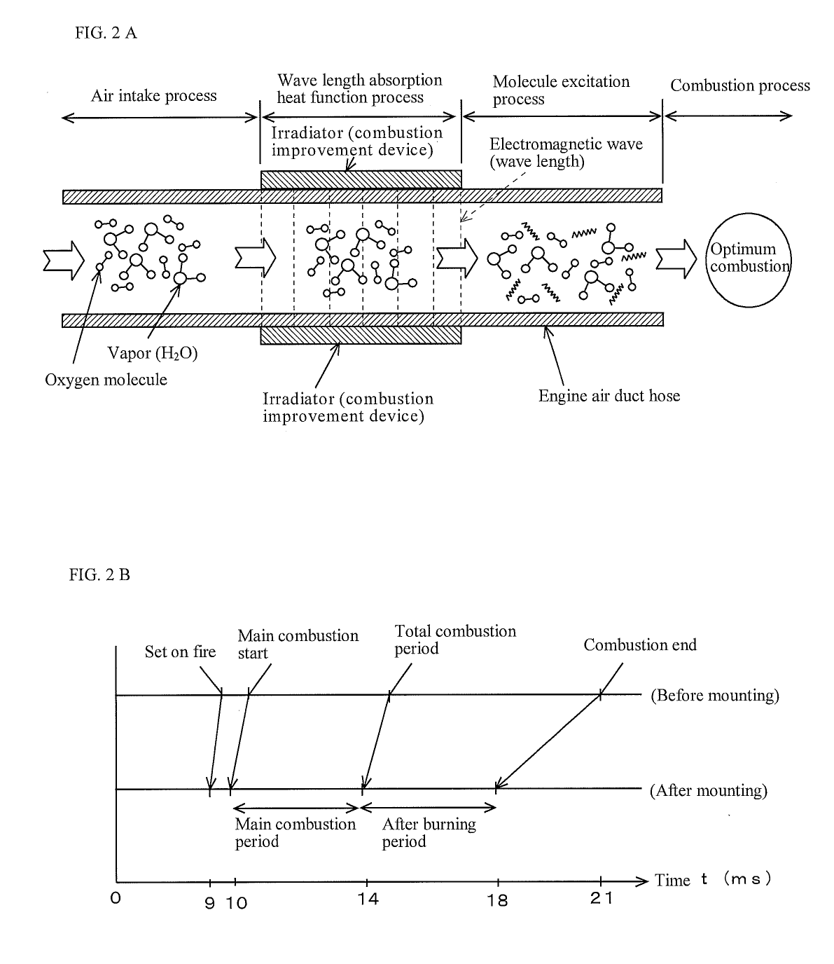

The fuel consumption reduction amount calculation device and the carbon dioxide emission reduction amount calculation device according to the present disclosure are explained based on the drawings. FIG. 1(a) and FIG. 1(b) are schematic diagrams showing an example of the combustion improvement device used in the present disclosure. FIG. 2A and FIG. 2B are schematic diagrams showing the principle of the combustion improvement device and combustion improvement effect used in the present disclosure. FIG. 2A is a schematic diagram showing the principle of the combustion improvement device, and FIG. 2B is a schematic diagram showing the combustion improvement effect.

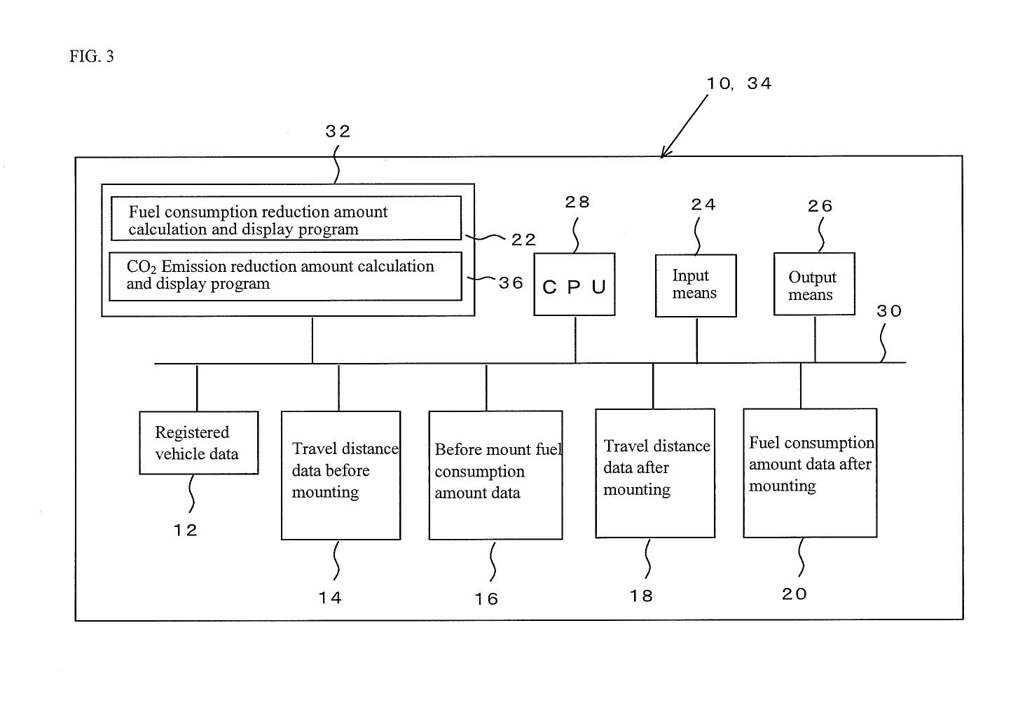

FIG. 3 is a block diagram of a fuel consumption reduction amount calculation device and the carbon dioxide emission reduction amount calculation device according to the present disclosure.

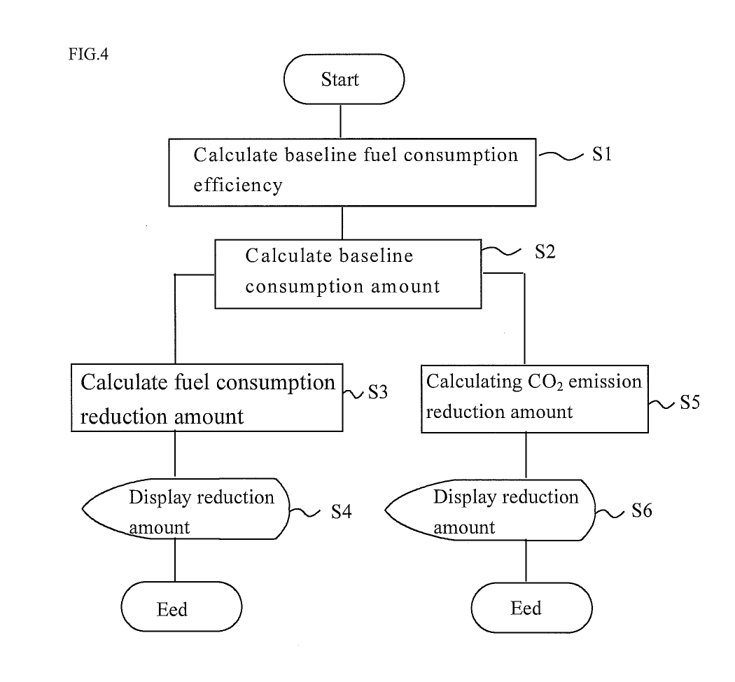

FIG. 4 is a flow chart of the fuel consumption reduction amount calculation and display program and the carbon dioxide emission reduction amount calculation and display program according to the present disclosure which operate in the fuel consumption reduction amount calculation device and the carbon dioxide emission reduction amount calculation device according to the present disclosure,

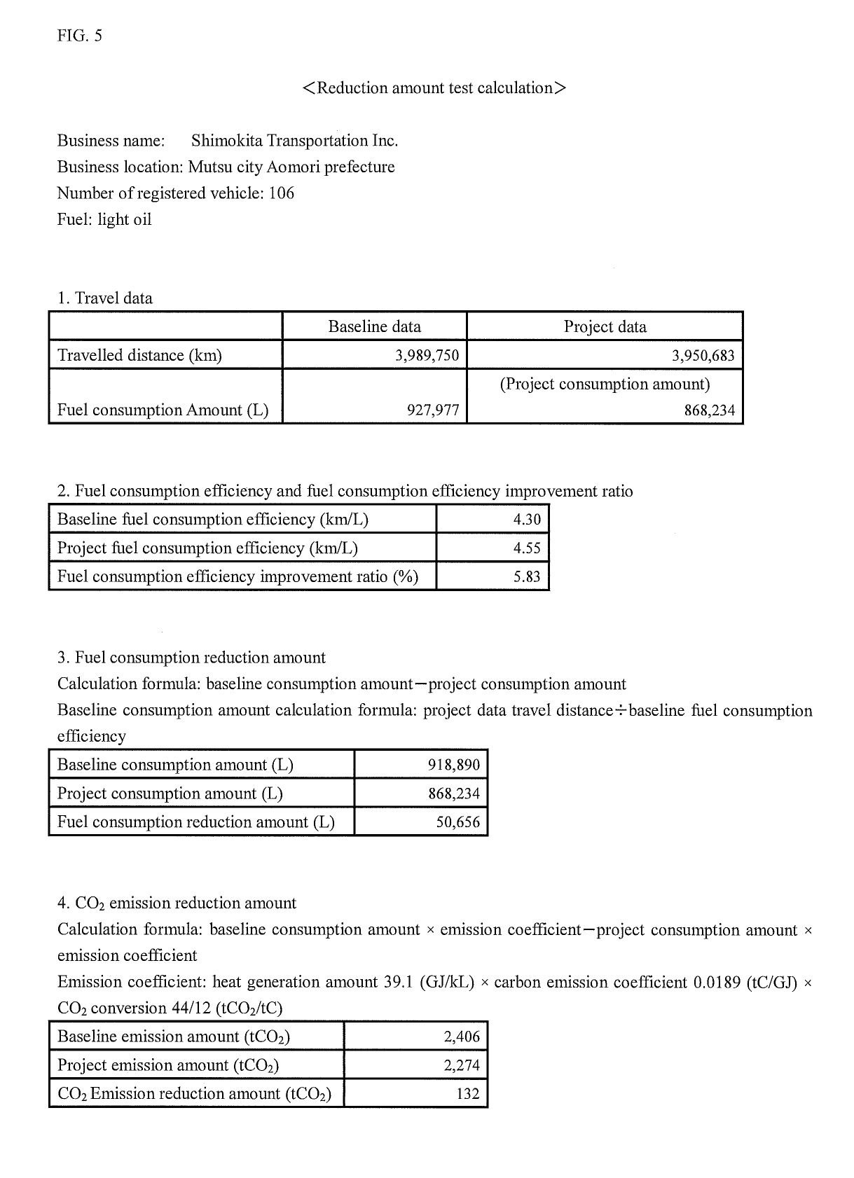

FIG. 5 is an example of display contents such as the fuel consumption reduction amount and the carbon dioxide emission reduction amount displayed on the output means of the fuel consumption reduction amount calculation device and the carbon dioxide emission reduction amount calculation device according to the present disclosure.

A fuel consumption reduction amount calculation device according to the present disclosure that causes to input, via an input means, baseline data which is travel data that comprises an annual travel distance and an annual fuel consumption amount of a vehicle stationed in a business facility located at a certain location, the baseline data being of the vehicle before mounting a combustion improvement device that improves fuel combustion in an internal combustion engine of the vehicle, and input project data of the vehicle after mounting the combustion improvement device, and

displays via an output means with a numerical value calculated by subtracting the annual fuel consumption amounts taken from the project data from baseline consumption amount which is the annual travel distance taken from the project data divided by the baseline fuel consumption efficiency calculated by dividing the annual travel distance taken from the baseline data by the annual fuel consumption amount, the numerical value being the subtracted value if the annual fuel consumption amount taken from the project data is smaller than the baseline consumption amount, and the numerical value being minus value if the annual fuel consumption amount taken from the project data is larger than the baseline consumption amount.

A fuel consumption reduction amount calculation and display program according to the present disclosure executed by the above-mentioned fuel consumption reduction amount calculation device causes to execute:

a step for calculating a baseline fuel consumption efficiency which is obtained by dividing the annual travel distance taken from the baseline data by the annual fuel consumption amount;

a step for calculating a baseline consumption amount which is obtained by dividing the annual travel distance taken from the project data by the baseline fuel consumption efficiency;

a step for calculating a fuel consumption reduction amount which is obtained by subtracting the annual fuel consumption amount taken from the project data from the baseline fuel consumption amount; and

a step for displaying the fuel consumption reduction amount on an output means with the numerical value of the calculated fuel consumption reduction amount if the annual fuel consumption amount taken from the project data is smaller than the baseline consumption amount, and the numerical value being minus value if the annual fuel consumption amount taken from the project data is larger than the baseline consumption amount.

“A vehicle stationed in a business facility located at a certain location” in the present disclosure is, for example, a vehicle that starts an operation always from an identical business facility (the same point), and that receives maintenances (repair, a periodic check and the like of a vehicle) always in the same repair shop.

A vehicle that lacks either one taken from baseline data or project data, or a part of the data, for example, disused vehicles and newly registered vehicles are not included. Travel data taken from baseline data and project data are of the same vehicle.

The term “annual” in the present disclosure may be at least 12 months, or may be an integral multiple of 12 months.

This also applies to “a vehicle stationed in a business facility located at a certain location” and the term “annual” in the carbon dioxide emission reduction amount calculation device and the carbon dioxide emission reduction amount calculation and display program according to the present disclosure.

The above-mentioned combustion improvement device used in the present example is explained based on FIG. 1. The combustion improvement device of FIG. 1 is what the applicant of the present application manufactures and sells (product name: E-S/V (Eco-Supporter/Vehicle).). This combustion improvement device is belt-shaped in which a heat shielding material is disposed on the back side of a base material, and an irradiator that irradiates electromagnetic waves onto the heat shielding material is provided. The combustion improvement device is wound around the engine air intake system pipe (engine air duct hose) of a vehicle, and a hook and loop fastener B is stuck and attached to a hook and loop fastener A (FIG. 1 (a)). Electromagnetic waves (wavelength of far-infrared rays of 4-24 micrometer) are irradiated from the irradiator (FIG. 1 (b)) of combustion improvement device (FIG. 2 (a)). Electromagnetic waves are absorbed into vapor (H₂O) in the intake air by attaching the combustion improvement device to the engine air intake system pipe, and the optimal combustion can be obtained (FIG. 2 (a)). Moreover, the FIA cetane number which is an index of the ignition ability of the fuel in the fuel firing examination improves by installing the combustion improvement device. Furthermore, the main combustion period which shows flammability and the afterburning period determining the burning characteristics in the latter half of combustion are shortened (FIG. 2 (b)). It is conventionally known that the combustion improvement device which has such an effect improves fuel combustion, fuel consumption efficiency, and reducing the emission amount of CO₂ and the like by mounting on the internal combustion engine of a vehicle (for example, Japanese Patent Application Publication No. H7-.59972).

In addition, regarding the combustion improvement device shown in FIG. 1, a type depending on the displacement volume and the fuel type of the vehicle on which the combustion improvement device is on is assumed to be used. The combustion improvement device of FIG. 1 (b) is one for mounting on a vehicle of 2500 cc of displacement volume and fuel classification—light oil.

Moreover, the combustion improvement device in the disclosure of the present application is not limited to the products of the applicant of the present application but may be what improves fuel combustion for the internal combustion engine of a vehicle.

The fuel consumption reduction amount calculation device 10 shown in FIG. 3 is a computer installed in the business facility located at a certain location. The fuel consumption reduction amount calculation device 10 includes registered vehicle data 12, travel distance data 14 of the registered vehicles before mounting the combustion improvement device, fuel consumption amount data 16 of the registered vehicles before mounting the combustion improvement device, travel distance data 18 of the registered vehicles after mounting the combustion improvement device, fuel consumption amount data 20 of the registered vehicles before mounting the combustion improvement device, fuel consumption amount calculation and display program 22, input means 24, and output means 26.

The input means 24 inputs data and provides an instruction into the fuel consumption reduction amount calculation device 10 and is an input device such as a keyboard, a mouse and the like connected to a computer. The output means 26 is apparatus for an output connected to computers, such as a display (monitoring device) and a printer. According to the command from a CPU28 (central processing unit), an input screen and an output screen are displayed on a display. A keyboard, a mouse, and the like are connected to an input interface which is not illustrated, and the input interface transmits the signal transmitted from a keyboard, a mouse, and the like to the CPU28 via a bus 30 (signal line).

The CPU28 reads and executes the fuel consumption amount calculation and display program 22 in the memory device 32, and processes the information on the various data 12, 14, 16, 18, 20 and the like. The CPU28 is connected to the input and output circuits and the memory device which store the various data 12, 14, 16, 18, and 20 via the bus 30. A monitoring device and the like are connected via the input and output circuit, and the CPU28 exchanges data, a program, and the like.

The registered vehicle data 12 is identification data of the vehicle stationed in one business facility (including each business location of transportation business having business facilities in multiple areas). Identification data, for example, are types of combustion improvement devices to be mounted, a vehicle number (registration number), a vehicle manufacturer and model number, car delivery time, the latest automobile inspection day, displacement volume, and the like.

The travel distance data 14 of the registered vehicle before mounting the combustion improvement device is the annual travel distance of the vehicle recorded in the registered vehicle data 12. The travel distance data 14 is calculated by inputting monthly travel distances for every vehicle, calculating the total travel distance for 12 months, and adding the total travel distance of all registered vehicles.

The fuel consumption amount data 16 of the registered vehicle before mounting the combustion improvement device is the annual fuel consumption amount of the vehicle recorded in the registered vehicle data 12. The fuel consumption amount data 16 is calculated by inputting monthly fuel consumption amounts for every vehicle, calculating the total fuel consumption amount for 12 months, and adding the total fuel consumption amount of all registered vehicles.

The fuel consumption rate of all the registered vehicles in the business facility in which the baseline fuel consumption reduction amount calculation device 10 is installed is calculated by dividing the travel distance data 14 by the fuel consumption amount data 16.

In addition, in the present application, the travel data (annual travel distance and annual fuel consumption amount of a vehicle) before mounting the combustion improvement device is referred to as baseline data. Moreover, the annual travel distance of the vehicle taken from baseline data is denoted by D_{BL} (km/year), and annual fuel consumption amount is denoted by F_{BL} (L/year). Baseline fuel consumption efficiency is calculated by D_{BL}/F_{BL} (km/L).

Similar to the travel distance data 14 of the registered vehicle before mounting the combustion improvement device, the travel distance data 18 of the registered vehicles after mounting the combustion improvement device is the annual travel distance of the vehicle, on which the combustion improvement device is mounted, recorded in the registered vehicle data 12. The travel distance data 18 is calculated by inputting monthly travel distance for every vehicle, calculating the total travel distance for 12 months, and adding the total travel distance of all registered vehicles.

Similar to the fuel consumption amount data 16 of the registered vehicle before mounting the combustion improvement device, the fuel consumption amount data 20 of the registered vehicle before mounting the combustion improvement device is the annual fuel consumption amount of the vehicle, on which the combustion improvement device is mounted, recorded on the registered vehicle data 12. The fuel consumption amount data 20 is calculated by inputting monthly fuel consumption amount for every vehicle, calculating the total fuel consumption amount for 12 months, and adding the total fuel consumption amount of all registered vehicles.

The project fuel consumption efficiency (fuel consumption rate of all the registered vehicles on which a combustion improvement device is mounted in the office in which the fuel consumption reduction amount calculation device 10 is installed) is calculated by dividing the travel distance data 18 by the fuel consumption amount data 20. In the present application, the travel data after mounting the combustion improvement device (annual travel distance and annual fuel consumption amount of a vehicle) is referred to as project data. The annual travel distance of the vehicle concerning project data is denoted by D_{PJ} (km/year), and annual fuel consumption amount of the vehicle concerning project data is denoted by F_{PJ} (L/year). Moreover, the annual fuel consumption amount F_{PJ} of project data is referred to as project consumption amount. Project fuel consumption efficiency is calculated by D_{PJ}/F_{PJ} (km/L).

In FIG. 3, operation of the fuel consumption amount calculation and display program 22 which CPU28 executes is explained based on FIG. 4. The flow of FIG. 4 starts in a state where baseline data and project data are stored. A baseline fuel consumption efficiency D_{BL}/F_{BL} is calculated (Step S1) by dividing the annual travel distance D_{BL} taken from baseline data by the annual fuel consumption amount F_{BL}.

Then, a baseline consumption amount (D_{PJ}×F_{BL}/D_{BL}) is calculated by dividing the annual travel distance D_{PJ} taken from project data by baseline fuel consumption efficiency D_{BL}/F_{BL} (Step S2).

Then, a fuel consumption reduction amount is calculated by subtracting the project consumption amount F_{PJ} from the baseline consumption amount (D_{PJ}×F_{BL}/D_{BL}) (Step S3) to display the reduction amount on the output means 26 (Step S4).

This can visualize the fuel consumption reduction amount in the business facility in which the fuel consumption reduction amount calculation device 10 is installed

### Test Example

The fuel consumption reduction amount of one business facility in which 106 vehicles (buses) are stationed, the vehicles using light oil as fuel, was calculated using the fuel consumption reduction amount calculation device 10 and displayed. Then, travel data (baseline data and project data), fuel consumption efficiency and the fuel consumption efficiency improvement rate, and the fuel consumption reduction amount were displayed as shown in FIG. 5.

In addition, the above-mentioned 106 vehicles (buses) are vehicles which are maintained (repair of vehicles, a periodic check, and the like.) in one repair shop which the transportation contractor who owns the vehicles operates.

Moreover, project data is travel data for one year after mounting the combustion improvement device, and baseline data is travel data for one year before mounting the combustion improvement device.

### (Travel Data)

The baseline data are the annual travel distance D_{BL} (total annual travel distance of registered vehicles) 3,989,750 (km/year), and the annual fuel consumption amount F_{BL} (annual fuel consumption amount of registered vehicles) 927,977 (L/year).

Project data are annual travel distance D_{PJ} (total annual travel distance of registered vehicles on which a combustion improvement device is mounted) 3,950,683 (km/year), and project consumption amount F_{PJ} (annual fuel consumption amount of registered vehicles on which a combustion improvement device is mounted) 868,234 (L/year).

### (Fuel Consumption Efficiency and Fuel Consumption Efficiency Improvement Rate)

The baseline fuel consumption efficiency D_{BL}/F_{BL} is 4.30 (km/L), and project fuel consumption efficiency is D_{PJ}/F_{PJ} is 4.55 (km/L). A fuel consumption efficiency improvement rate is calculated by dividing the difference between the baseline fuel consumption efficiency and project fuel consumption efficiency by the baseline fuel consumption efficiency, the difference being calculated by subtracting the baseline fuel consumption efficiency from project fuel consumption efficiency. The fuel consumption efficiency improvement rate in the above-mentioned test example is 5.83%.

### (Fuel Consumption Reduction Amount)

A baseline consumption amount (D_{PJ}×F_{BL}/D_{BL}) is calculated as 918,890 (L/year), and as the project consumption amount is 868,234 (L/year), the fuel consumption reduction amount is displayed as 50,656 (L/year).

The fuel consumption reduction amount calculation device 10 could digitize (calculate) the fuel consumption reduction amount of the business facility and could display.

In addition, the fuel consumption reduction amount is calculated by the multiplication of the project consumption amount and the fuel consumption efficiency improvement rate.

Subsequently, the carbon dioxide emission reduction amount calculation device and the carbon dioxide emission reduction amount calculation and display program of the present disclosure are explained based on FIG. 3 and FIG. 4.

The carbon dioxide emission reduction amount calculation device of the present disclosure is a carbon dioxide emission reduction amount calculation device that inputs, via an input means, baseline data which is travel data that comprises an annual travel distance and an annual fuel consumption amount of a vehicle stationed in a business facility located at a certain location, the baseline data being of the vehicle before mounting a combustion improvement device that improves fuel combustion in an internal combustion engine of the vehicle, and inputs project data of the vehicle after mounting the combustion improvement device, and

displays via an output means with a numerical value calculated by subtracting project emission amount which is calculated by multiplying the emission coefficient by the annual fuel consumption amount taken from the project data, from baseline emission amount which is calculated by multiplying the emission coefficient of the fuel of the vehicle by a baseline consumption amount which is the annual travel distance taken from the project data divided by the baseline fuel consumption efficiency calculated by dividing the annual travel distance taken from the baseline data by the annual fuel consumption amount, the numerical value being the subtracted value if the project emission amount is smaller than the baseline emission amount, and the numerical value being minus value if the project emission amount is larger than the baseline emission amount.

Moreover, the carbon dioxide emission reduction amount calculation and display program of the present disclosure performed by the above-mentioned carbon dioxide emission reduction amount calculation device is a carbon dioxide emission reduction amount calculation and display program that causes a computer;

to execute:

a step for calculating a baseline fuel consumption efficiency which is obtained by dividing the annual travel distance taken from the baseline data by the annual fuel consumption amount;

a step for calculating a baseline consumption amount which is obtained by dividing the annual travel distance taken from the project data by the baseline fuel consumption efficiency;

a step for calculating a carbon dioxide emission reduction amount calculated by subtracting project emission amount calculated by multiplying the emission coefficient by the annual fuel consumption amount taken from the project data from the baseline emission amount calculated by multiplying the emission coefficient of the fuel of the vehicle by baseline consumption amount; and

a step for displaying the carbon dioxide emission reduction amount on an output means.

The carbon dioxide (CO₂) emission reduction amount calculation and display program 36 is stored in the memory device 32 in the carbon dioxide emission reduction amount calculation device 34 of FIG. 3. The explanations of other components of the device 34 are not explained here, but rather are explained in the explanation of the fuel consumption reduction amount calculation device 10.

Moreover, the above-mentioned emission coefficient is expressed by calorific value per unit usage fee HV(GJ/L)×the carbon emission amount per calorific value unit CF (tC/GJ)×CO₂ conversion 44/12 (tCO₂/tC), which relates to the fuel of a vehicle (emission coefficient in the calculation formula of the green house effect gas emission amount based on the Act on Promotion of Global Warming Countermeasures (the PGWC act)). In addition, the calorific value HV of light oil fuel is 39.1 (GJ/kL) and carbon emission amount CF is 0.0189 tC/GJ.

The operation of the CO₂ emission amount calculation and display program 36 which CPU28 executes is explained in FIG. 3 based on FIG. 4. The flow of FIG. 4 starts in a state in which baseline data and project data are accumulated.

Baseline fuel consumption efficiency D_{BL}/F_{BL} is calculated by dividing the annual travel distance D_{BL} taken from baseline data by the annual fuel consumption amount F_{BL} (Step S1).

Then, a baseline consumption amount (D_{PJ}×F_{BL}/D_{BL}) is calculated by dividing the annual travel distance D_{PJ} taken from project data by baseline fuel consumption efficiency D_{BL}/F_{BL} (Step S2).

Then, a CO₂ emission reduction amount is calculated by subtracting the project emission amount, which is calculated by multiplying the emission coefficient by the project consumption amount F_{PJ}, from the baseline emission amount, which is calculated by multiplying the emission coefficient of the fuel of the above-mentioned vehicle by the baseline consumption amount (Step S5) to display the reduction amount on the output means 26 (Step S6).

This can visualize the CO₂ emission reduction amount in the business facility in which the carbon dioxide emission reduction amount calculation device 34 is installed

### Test Example

The CO₂ emission reduction amount regarding the travel data shown in FIG. 5 was calculated using the carbon dioxide emission reduction amount calculation device 34. The CO₂ emission reduction amount was displayed as shown in FIG. 5.

### (The CO₂ Emission Reduction Amount)

The baseline emission amount (D_{PJ}×F_{BL}/D_{BL}×emission coefficient) was calculated as 2,406 (tCO₂). The project emission amount (D_{PJ}×F_{BL}/D_{BL}×emission coefficient) was calculated as 2,274 (tCO₂), and the CO₂ emission reduction amount was displayed as 132 (tCO₂).

As described above, the carbon dioxide emission reduction amount calculation device 34 could digitize (calculate) and display the CO₂ emission reduction amount of the business facility.

In the above-mentioned test example, the numerical values (displayed value) displayed on the display screen of FIG. 5 are rounded calculated values calculated by the fuel consumption reduction amount calculation device 10 and the carbon dioxide emission reduction amount calculation device 34 using input numerical values (input values). Moreover, the calculated values were calculated based on the input values, and were not calculated based on the displayed value.

In calculating the fuel consumption reduction amount and the CO₂ emission reduction amount, the above-mentioned reduction amount can be calculated without being affected by fluctuation of fuel consumption reduction due to variation of driving conditions of four seasons by limiting to using annual vehicles data and by limiting vehicles that start from the same location (business facility).

Moreover, the applicant of the present patent application has received a certificate, certifying that the calculation method (calculation formula) of the CO₂ emission reduction amount in the above examples is an objective and rational calculation method, from the third party examination organization of green house effect gas emission (Japan Smart Energy, Inc., 1-4-9, Nishi-Shimbashi, Minato-ku, Tokyo) (the Japan Smart Energy, Inc. certification no. 2305003 (independent emission validation), name of business “third party certificate on the calculation method of the CO₂ emission reduction amount by Eco-Supporter/Vehicle”, certificate-of-attestation date-of-issue Jan. 23, 2012.

According to the calculation of the fuel consumption reduction amount, and/or the carbon dioxide emission reduction amount using the present disclosure, the reduction amount may be displayed with a minus numerical value in some business facilities. Reasons for a minus value are considered to be, for example, a case where (model of) the combustion improvement device is not compatible with the vehicle on which the combustion improvement device is mounted, a case in which the internal combustion engine of the vehicle on which the combustion improvement device is mounted has a defect, and the like.

Therefore, by visualization of the fuel consumption reduction amount and/or the carbon dioxide emission reduction amount, by the present disclosure, we can find each above-mentioned case to handle.

Moreover, visualization of the fuel consumption reduction amount and the carbon dioxide emission reduction amount of vehicles are mentioned in the above-mentioned. Also, when a combustion improvement device is installed in the internal combustion engine of driers and other heating appliances

the fuel consumption reduction amount and/or the carbon dioxide emission reduction amount of heating appliances can be visualized.

In a case of driers and other heating appliances, “the travel data that includes the annual travel distance and annual fuel consumption amount of the vehicle stationed in the business facility located at a certain location” in the case of a vehicle, is “combustion data that includes the annual combustion time and annual fuel consumption amount of driers and other heating appliances that are installed permanently in a certain location.” In addition, in the above-mentioned examples, “travel distance” shall be read as “combustion time” of heating appliances.

### REFERENCE SIGNS LIST

10 Fuel consumption reduction amount calculation device
24 Input Means
26 Output Means
14 and 18 Travel distance data
16 and 20 Fuel consumption amount data
22 Fuel consumption reduction amount calculation and display program
34 Carbon dioxide emission reduction amount calculation device
36 Carbon dioxide emission reduction amount calculation and display program

1-8. (canceled)

9. A reduction amount calculation device comprising:
an inputter configured to receive baseline data and project data, wherein
the baseline data comprises a time-or-distance parameter and an annual fuel consumption amount by a fuel consumption device before mounting a combustion improvement device onto the fuel consumption device,
the combustion improvement device configured to improve fuel combustion of the fuel consumption device, and
the project data comprises a time-or-distance parameter and an annual fuel consumption amount by the fuel consumption device after the mounting of the combustion improvement device;
a calculator configured to calculate a numerical value, a baseline consumption amount, and a baseline fuel consumption efficiency, wherein
the baseline fuel consumption efficiency is calculated by dividing the time-or-distance parameter of the baseline data by the annual fuel consumption amount of the baseline data,
the baseline consumption amount is calculated by dividing the time-or-distance parameter of the project data by the baseline fuel consumption efficiency, and
the numerical value is calculated by subtracting the annual fuel consumption amount of the project data from the baseline consumption amount; and
a display configured to display the calculated numerical value.

10. The reduction amount calculation device of claim 9, wherein
the fuel consumption device is an internal combustion engine of a vehicle, the vehicle stationed in a business facility located at a certain location,
the time-or-distance parameter is an annual travel distance, and
the numerical value represents a fuel consumption reduction amount by the vehicle.

11. The reduction amount calculation device of claim 9, wherein
the fuel consumption device is an internal combustion engine of a vehicle, the vehicle stationed in a business facility located at a certain location,
the time-or-distance parameter is an annual travel distance,
the calculator is further configured to calculate an emission coefficient, and multiple the emission coefficient by the numerical value to obtain the calculated numerical value, wherein the emission coefficient is expressed by a calorific value per unit usage multiplied by a carbon emission amount per calorific value unit, which relates to a greenhouse effect gas emission amount, and
the calculated numerical value represents a carbon dioxide emission reduction amount by the vehicle.

12. The reduction amount calculation device of claim 9, wherein
the fuel consumption device is a heating appliance, the heating appliance permanently installed at a certain location,
the time-or-distance parameter is an annual combustion time, and
the calculated numerical value represents a fuel consumption reduction amount by heating device.

13. The reduction amount calculation device of claim 9, wherein
the fuel consumption device is a heating appliance, the heating appliance permanently installed at a certain location,
the time-or-distance parameter is an annual combustion time,
the calculator is further configured to calculate an emission coefficient, and multiple the emission coefficient by the numerical value to obtain the calculated numerical value, wherein the emission coefficient is expressed by a calorific value per unit usage multiplied by a carbon emission amount per calorific value unit, which relates to a greenhouse effect gas emission amount, and
the calculated numerical value represents a carbon dioxide emission reduction amount by the vehicle.

14. A reduction amount calculation method comprising:
receiving baseline data and project data, wherein
the baseline data comprises a time-or-distance parameter and an annual fuel consumption amount by a fuel consumption device before mounting a combustion improvement device onto the fuel consumption device,
the combustion improvement device configured to improve fuel combustion of the fuel consumption device, and
the project data comprises a time-or-distance parameter and an annual fuel consumption amount by the fuel consumption device after the mounting of the combustion improvement device;
calculating a numerical value, a baseline consumption amount, and a baseline fuel consumption efficiency, wherein
the baseline fuel consumption efficiency is calculated by dividing the time-or-distance parameter of the baseline data by the annual fuel consumption amount of the baseline data,
the baseline consumption amount is calculated by dividing the time-or-distance parameter of the project data by the baseline fuel consumption efficiency, and
the numerical value is calculated by subtracting the annual fuel consumption amount of the project data from the baseline consumption amount; and
displaying the calculated numerical value.

15. The reduction amount calculation method of claim 14, wherein
the fuel consumption device is an internal combustion engine of a vehicle, the vehicle stationed in a business facility located at a certain location,
the time-or-distance parameter is an annual travel distance, and
the numerical value represents a fuel consumption reduction amount by the vehicle.

16. The reduction amount calculation method of claim 14, wherein
the fuel consumption device is an internal combustion engine of a vehicle, the vehicle stationed in a business facility located at a certain location,
the time-or-distance parameter is an annual travel distance,
the calculator is further configured to calculate an emission coefficient, and multiple the emission coefficient by the numerical value to obtain the calculated numerical value, wherein the emission coefficient is expressed by a calorific value per unit usage multiplied by a carbon emission amount per calorific value unit, which relates to a greenhouse effect gas emission amount, and
the calculated numerical value represents a carbon dioxide emission reduction amount by the vehicle.

17. The reduction amount calculation method of claim 14, wherein
the fuel consumption device is a heating appliance, the heating appliance permanently installed at a certain location,
the time-or-distance parameter is an annual combustion time, and
the calculated numerical value represents a fuel consumption reduction amount by heating device.

18. The reduction amount calculation method of claim 14, wherein
the fuel consumption device is a heating appliance, the heating appliance permanently installed at a certain location,
the time-or-distance parameter is an annual combustion time,
the calculator is further configured to calculate an emission coefficient, and multiple the emission coefficient by the numerical value to obtain the calculated numerical value, wherein the emission coefficient is expressed by a calorific value per unit usage multiplied by a carbon emission amount per calorific value unit, which relates to a greenhouse effect gas emission amount, and
the calculated numerical value represents a carbon dioxide emission reduction amount by the vehicle.

19. A non-transitory computer-readable medium comprising: instructions that, when executed by a processor, cause the processor to perform that following method:
receiving baseline data and project data, wherein
the baseline data comprises a time-or-distance parameter and an annual fuel consumption amount by a fuel consumption device before mounting a combustion improvement device onto the fuel consumption device,
the combustion improvement device configured to improve fuel combustion of the fuel consumption device, and
the project data comprises a time-or-distance parameter and an annual fuel consumption amount by the fuel consumption device after the mounting of the combustion improvement device;
calculating a numerical value, a baseline consumption amount, and a baseline fuel consumption efficiency, wherein
the baseline fuel consumption efficiency is calculated by dividing the time-or-distance parameter of the baseline data by the annual fuel consumption amount of the baseline data,
the baseline consumption amount is calculated by dividing the time-or-distance parameter of the project data by the baseline fuel consumption efficiency, and
the numerical value is calculated by subtracting the annual fuel consumption amount of the project data from the baseline consumption amount; and
displaying the calculated numerical value.

20. The non-transitory computer-readable medium of claim 19, wherein
the fuel consumption device is an internal combustion engine of a vehicle, the vehicle stationed in a business facility located at a certain location,
the time-or-distance parameter is an annual travel distance, and
the numerical value represents a fuel consumption reduction amount by the vehicle.

21. The non-transitory computer-readable medium of claim 19, wherein
the fuel consumption device is an internal combustion engine of a vehicle, the vehicle stationed in a business facility located at a certain location,
the time-or-distance parameter is an annual travel distance,
the calculator is further configured to calculate an emission coefficient, and multiple the emission coefficient by the numerical value to obtain the calculated numerical value, wherein the emission coefficient is expressed by a calorific value per unit usage multiplied by a carbon emission amount per calorific value unit, which relates to a greenhouse effect gas emission amount, and
the calculated numerical value represents a carbon dioxide emission reduction amount by the vehicle.

22. The non-transitory computer-readable medium of claim 19, wherein
the fuel consumption device is a heating appliance, the heating appliance permanently installed at a certain location,
the time-or-distance parameter is an annual combustion time, and
the calculated numerical value represents a fuel consumption reduction amount by heating device.

23. The non-transitory computer-readable medium of claim 19, wherein
the fuel consumption device is a heating appliance, the heating appliance permanently installed at a certain location,
the time-or-distance parameter is an annual combustion time,
the calculator is further configured to calculate an emission coefficient, and multiple the emission coefficient by the numerical value to obtain the calculated numerical value, wherein the emission coefficient is expressed by a calorific value per unit usage multiplied by a carbon emission amount per calorific value unit, which relates to a greenhouse effect gas emission amount, and
the calculated numerical value represents a carbon dioxide emission reduction amount by the vehicle.
